(19) United States
(12) Patent Application Publication
(10) Pub. No.: US 2025/0267468 A1
(43) Pub. Date: Aug. 21, 2025

(54) Spectrum Management

(71) Applicant: Comcast Cable Communications, LLC, Philadelphia, PA (US)

(72) Inventors: Jingjie Zhu, Erie, CO (US); Maher Harb, Wynnewood, PA (US); Daniel Rice, Boulder, CO (US); Jeffrey Howe, West Chicago, IL (US); Chad Humble, Parker, CO (US)

(21) Appl. No.: 18/442,320

(22) Filed: Feb. 15, 2024

(51) Int. Cl. H04W 16/14; H04W 72/50

(52) U.S. Cl. CPC H04W 16/14; H04W 72/50

(57) ABSTRACT

Systems, apparatuses, and methods are described for remotely reconfiguring the spectrum of a network based on a network profile associated with a service group. The service group may contain a group of modems that transmit and receive information over the spectrum of the network. The reconfigured spectrum may increase the network capacity of the network. The modems may continue to transmit and receive information while the reconfiguring is being implemented using intermediate bonding groups.

### BACKGROUND

The spectrum of a network may refer to the range of frequencies network devices use to transmit and receive information. A spectrum may further be subdivided into radio frequency (RF) channels. The spectrum may be recharacterized in response to technological improvements or other changing circumstances. Improving the network's characteristics, such as the network capacity, may be a factor in provisioning the network's spectrum. The process of provisioning a spectrum (i.e., adding, removing, and/or modifying RF channels) may be inefficient and time consuming if the network size is large and complex.

### SUMMARY

The following summary presents a simplified summary of certain features. The summary is not an extensive overview and is not intended to identify key or critical elements.

Systems, apparatuses, and methods are described for remotely reconfiguring a network profile. The network may include a service group or a set of service groups, each including a group of modems. A remote provisioner may receive information associated with a service group, such as the service group's network profile, which may include characteristics about the service group, the RF channel configuration of the service group, etc. The remote provisioner may compute an updated profile that increases the network capacity of the service group. A coordinator may use the updated profile to reconfigure the service group's network without an interruption to the network service of the service group. An advantage is the flexibility and efficiency of reconfiguring a set of service groups, each with their own unique network profile, in parallel.

According to aspects of the disclosure, methods of managing the spectrum of a network are provided. According to the methods, a spectrum associated with the network can be identified. Based on the spectrum, devices using the spectrum can be determined. A new channel configuration of the spectrum can be computed to increase capacity of the network. A portion of the spectrum that is unaffected by the new channel configuration can be determined. The devices can be reassigned to the unaffected portion of the spectrum using intermediate bonding groups. The new channel configuration can be implemented on the new spectrum after determining that the devices have been moved to the unaffected portion of the spectrum. The device can then be moved to a new portion of the spectrum based on the new channel configuration

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 is a schematic block diagram of a system that remotely reconfigures the network profile of a service group.

FIG. 4 is a schematic block diagram of a system that remotely reconfigures the network profiles of a set of service groups.

FIG. 5 is a flow chart showing an example method of computing a new channel configuration for a service group.

FIG. 6 is a flow chart showing an example method of implementing a new channel configuration for a service group.

FIGS. 7A-7D are a sequence showing an example method of remotely reconfiguring the network profile of a service group without an interruption to the network service of the service group.

FIGS. 8A-8B show an example of a current channel configuration and a new channel configuration.

FIG. 9 is a flow chart showing an example method of remotely reconfiguring a network.

FIG. 10 is a flow chart showing an example method of remotely reconfiguring a network.

FIG. 11 is a flow chart showing an example method of remotely reconfiguring a network.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

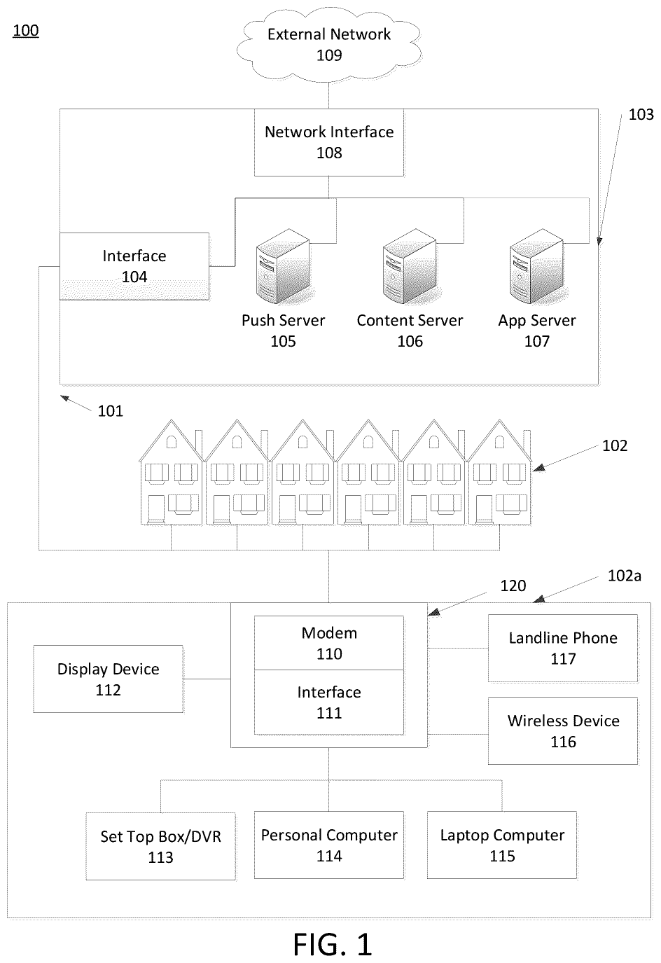

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, additional push, content, and/or application servers, and/or other types of servers. Although shown separately, the push server 105, the content server 106, the application server 107, and/or other server(s) may be combined. The servers 105, 106, 107, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

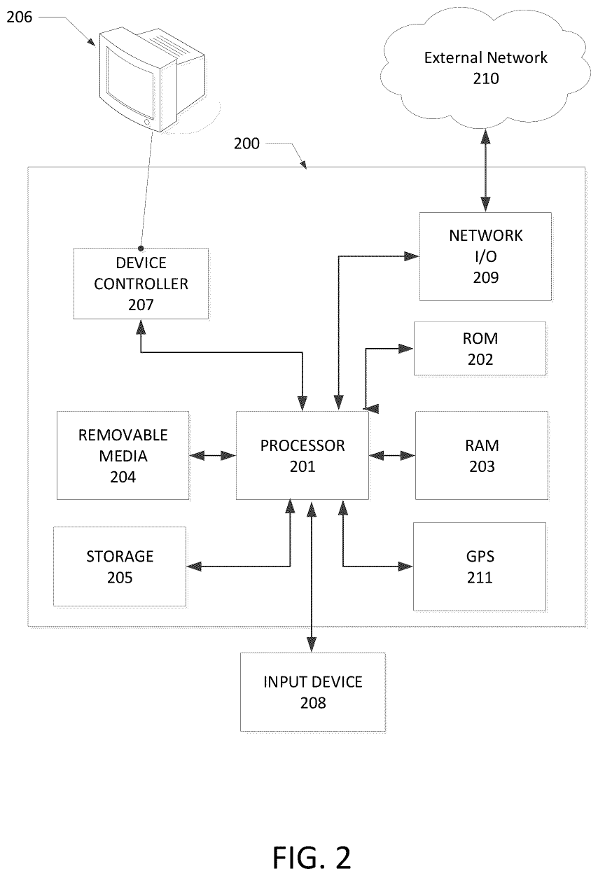

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., remote provisioner 310, coordinator 320, resource manager 330, remote physical device 340, modems 360₁-360_{N}, etc). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

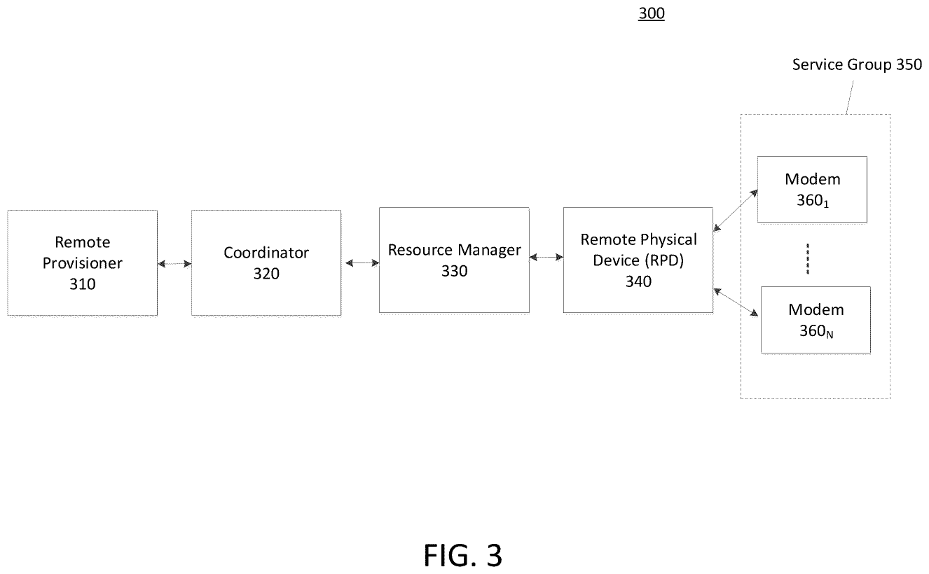

FIG. 3 is a schematic block diagram of a system that remotely reconfigures the network profile of a service group. Referring to FIG. 3, the system 300 may include a remote provisioner 310, a coordinator 320, a resource manager 330, a remote physical device (RPD) 340, a service group 350, and modems 360₁-360_{N}. The previously mentioned devices may include one or more physical components, such as one or more processors memories, communication interfaces, and/or the like, e.g., the computing device 200 of FIG. 2.

A network (e.g., communication network 100) may be segmented into multiple service groups, in which each service group (i.e., service group 350) uses a spectrum in a frequency range that includes a set of RF channels, optical wavelengths, or optical channels or subcarriers modulated onto an optical wavelength that a group of modems (i.e., modems 360₁-360_{N}) may use to receive or transmit information over the network. For example, in a hybrid fiber/coaxial distribution network, (i.e., a DOCSIS network), the service group 350 may include a combination D3.0 single carrier quadrature amplitude modulation (SC-QAM) channels and/or D3.1 orthogonal frequency division multiplexing (OFDM) channels. The service group 350 may further have a network profile that includes information about the service group 350 such as the current RF channel configuration, the characteristics of the modems 360₁-360_{N}, the network capacity of the service group, a set of configurations and/or constraints related to the service group 350, such as the minimum/maximum number of usable channels in the service group 350, minimum/maximum channel size, channel guard band size, frequency range, spectral efficiency, spectrum/channel utilization, and/or other characteristics and information.

The modems 360₁-360_{N} may be a group of modem devices, such as the modem devices 110 of FIG. 1, and may be computing devices, such as the computing device 200 of FIG. 2. Further, each of the modems 360₁-360_{N} in the service group 350 may have characteristics unique to the particular modem, such as a modem (e.g., modem 360₁) having D3.0 and/or D3.1 capabilities. For example, a 16-channel D3.0 SC-QAM modem may use 16 SC-QAM channels to transmit and receive information. Although the details discussed below are with respect to a service group using a combination of SC-QAM channels and/or OFDM channels in a hybrid fiber/coaxial distribution network, the present invention may be used for any type of spectrum in a network (e.g., wireless, coaxial, fiber, etc), channel configuration/modulation scheme (e.g., D4.0), and modems/modem devices without departing from the scope of the disclosure.

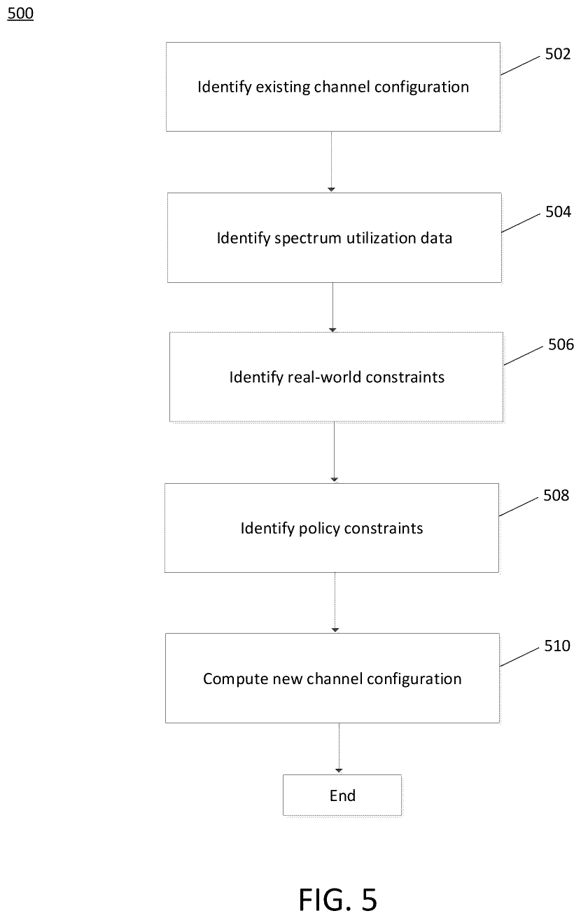

The remote provisioner 310 is a computing device that may be configured to receive information (e.g., information related to a service group's network profile, such as the current channel configuration). Moreover, this information may be used by the remote provisioner 310 to compute a new channel configuration as part of an updated network profile that increases the network capacity of the service group, as discussed in more detail in FIG. 5.

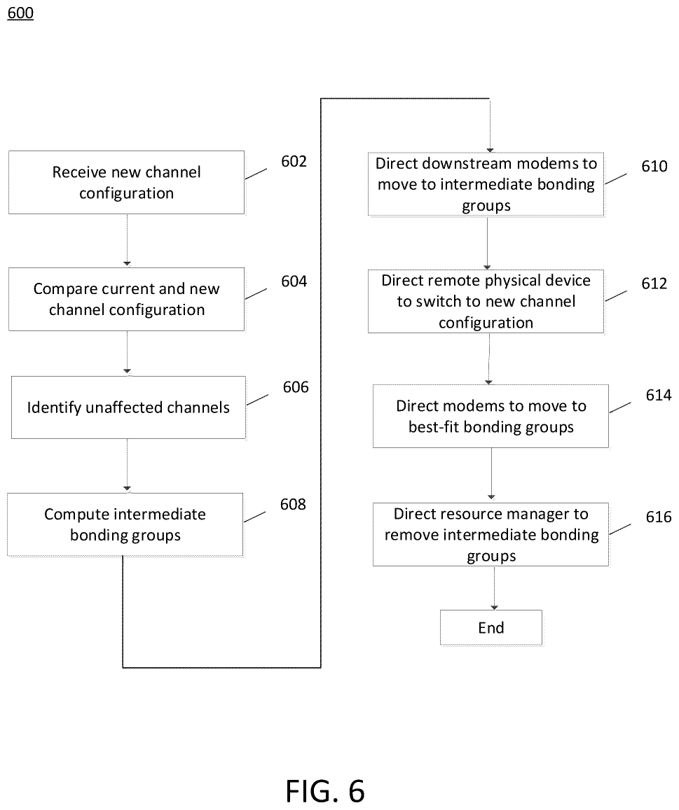

The coordinator 320 is a computing device that may gather and send information related to a service group's (e.g., service group 350) network profile to the remote provisioner 310, receive a new channel configuration from the remote provisioner 310, compare the new channel configuration of the service group 350 to the current channel configuration of the service group, identify unaffected channels based on differences between the current and new channel configuration, compute intermediate bonding groups, direct modems 360₁-360_{N} to move to intermediate bonding groups while the new channel configuration is being implemented, identify that the modems 360₁-360_{N} have been moved or reassigned to intermediate bonding groups, direct the modems to best-fit bonding groups after the new channel configuration is implemented, all without an interruption to the network performance of the modems 360₁-360_{N} (by utilizing the intermediate bonding groups) within the service group 350, as discussed in more detail in FIG. 6.

The remote provisioner 310 and/or the coordinator 320 may be a single or separate computing device, and may be located at the local office 103 and/or remotely at the external network 109. Remotely reconfiguring the network profile of a service group may provide more flexibility and efficiency as opposed to performing the reconfiguring locally.

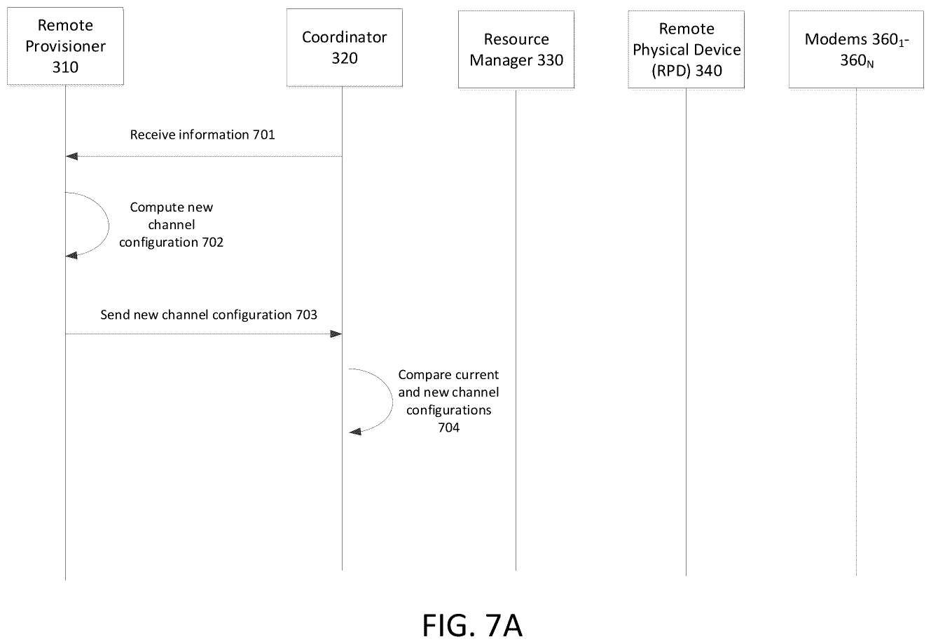

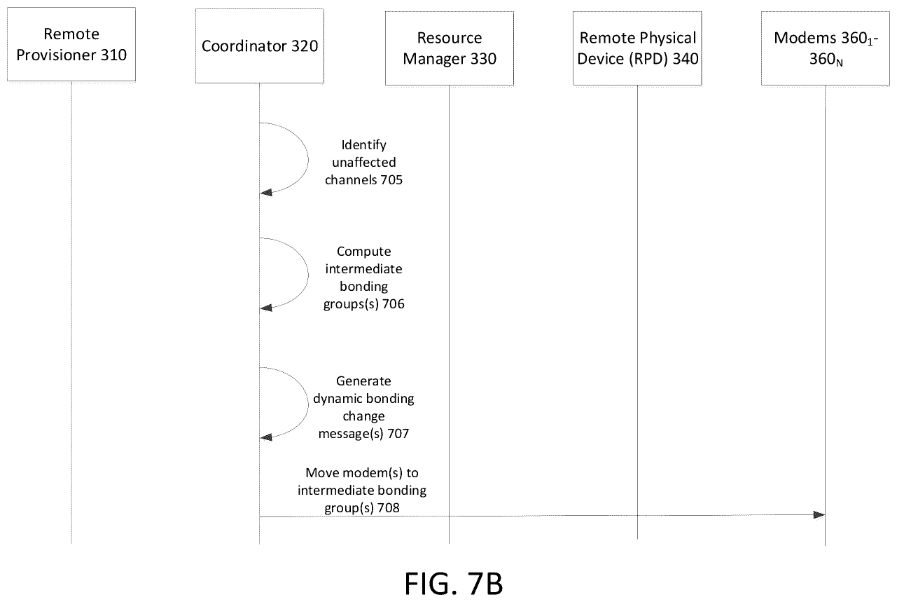

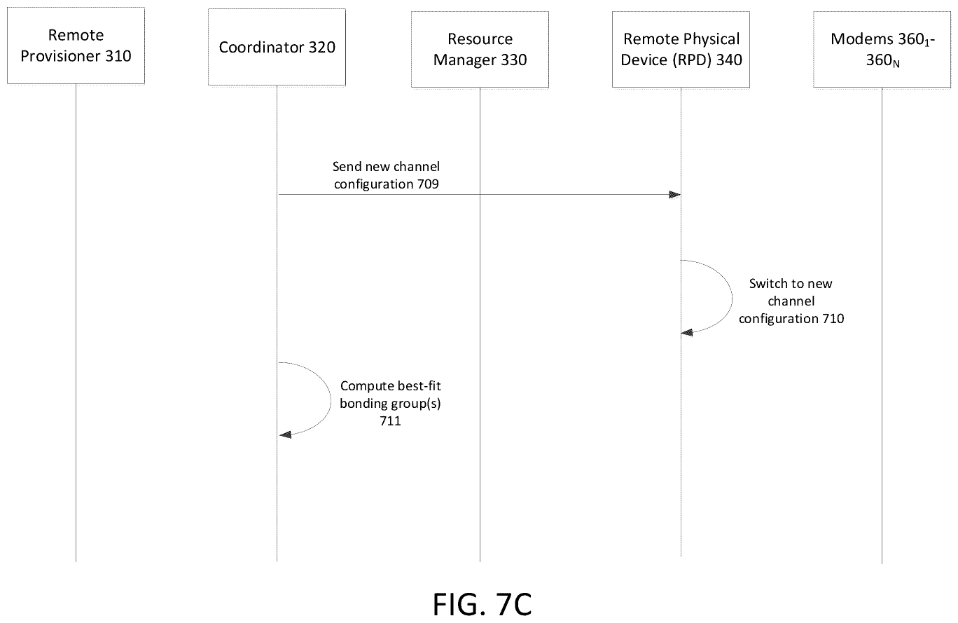

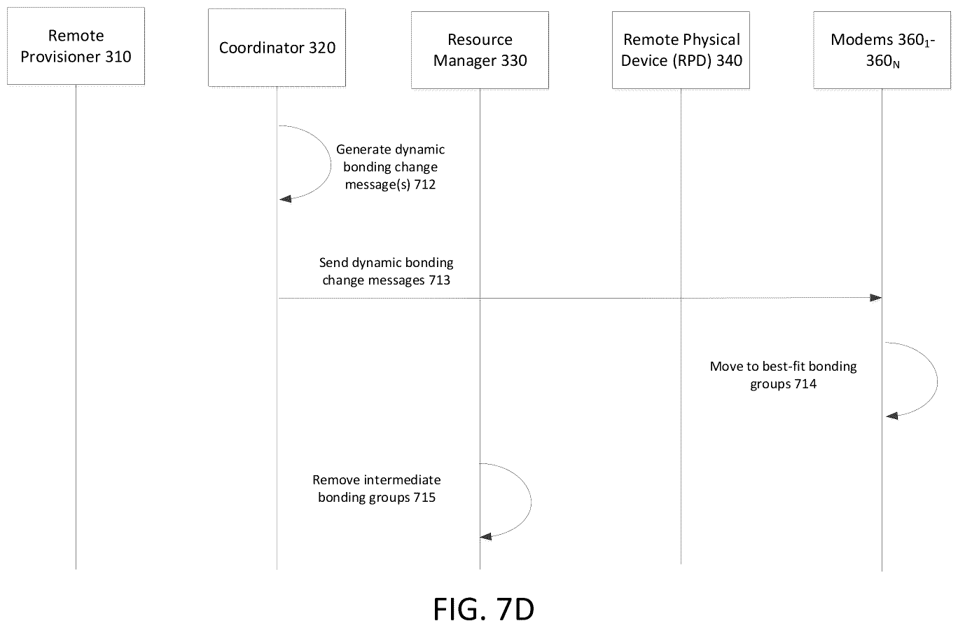

Resource manager 330 is a computing device (e.g., the computing device 200), which may, e.g., be part of the interface 104 at the local office 103. According to various embodiments, resource manager 330 may also comprise a cable modem termination system, an edge router, and/or digital subscriber line access multiplexer, to name a few non-limiting examples. Resource manager 330 may be used to monitor network traffic associated with modems 360₁-360_{N}. In some instances, resource manager 330 may be a cable modem termination system. The resource manager 330 may also receive messages (e.g., dynamic bonding change messages and/or other messages) from the coordinator 320, support the coordinator 320 in moving the modems 360₁-360_{N} to intermediate bonding groups and/or best-fit bonding groups, and in removing intermediate bonding groups, as discussed in more detail in FIG. 7.

The RPD 340 may be a transceiver that converts RF signals into data packets in an upstream transmission, and convert data packets to RF signals in a downstream transmission. The RPD 340 may be located in proximity to or co-located with the resource manager 330. The transceiver may be an antenna connected to a coaxial cable or optical fiber at the resource manager 330, and that coaxial cable may extend to the various homes (i.e., the multiple premises 102) in a particular region (e.g., service group 350) serviced by the resource manager 330. The RPD 340 may be configured to communicate with a group of modem devices, such as modems 360₁-360_{N}, via a plurality of RF channels configured for the transceiver. For example, the RPD 340 may convert data packets from the resource manager 330 to an RF signal and transmit the RF signal to modems 360₁-360_{N} via the RF channels configured for the RPD 340. The RPD 340 may further receive a new channel configuration from the coordinator 320 and/or commands from the coordinator 320 that direct the RPD 340 to switch from the current channel configuration to the new channel configuration, as discussed in more detail in FIG. 7.

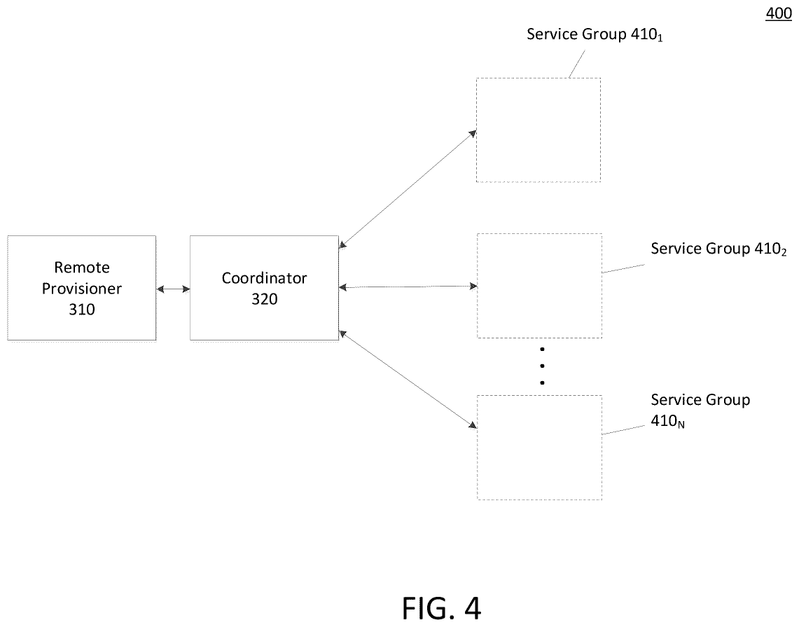

FIG. 4 is a schematic block diagram of a system that remotely reconfigures the network profile of a set of service groups. Similar to the system 300 described by FIG. 3, the system 400 may have a remote provisioner 310 and a coordinator 320 that perform similar functions. Although not shown, each of the service groups 4101, and 4102 through 410N may be connected to the coordinator 320 via a resource manager 330 and a remote physical device (RPD) 340 (i.e., a resource manager and RPD for service group 4101, a resource manager and RPD for service group 4102, etc). The remote provisioner 310 and the coordinator 320 may perform the previously mentioned functions with respect to FIG. 3 for a set of service groups, such as service groups 4101, and 4102 through 410N. In this manner, the network profile of each of the service groups 4101, and 4102 through 410N may be remotely reconfigured in parallel, and in doing so, increase the network capacity of each of the service groups 4101, and 4102 through 410N simultaneously.

FIG. 5 is a flow chart showing an example method of computing a new channel configuration for a service group. Although shown sequentially for clarity, steps 502-508 may be performed simultaneously and inputted together into step 510. Further, any of steps 502-508 may be performed in any order, may be omitted, and/or may be modified in some embodiments. Additionally, for ease of explanation, method 500 is discussed with respect to the system outlined in FIG. 3. However, it should be understood that the method 500 is not so limited to the specific embodiment of FIG. 3. The steps shown in FIG. 5 may serve as an example of how the remote provisioner 310 may receive information related to a service group's (e.g., service group 350) network profile and use those characteristics to compute a new channel configuration for the service group 350 as part of provisioning the new spectrum of the service group 350. In some instances the information identified by the remote provisioner 310 in steps 502-508 may be received from the coordinator 320 in response to a request by the remote provisioner 310.

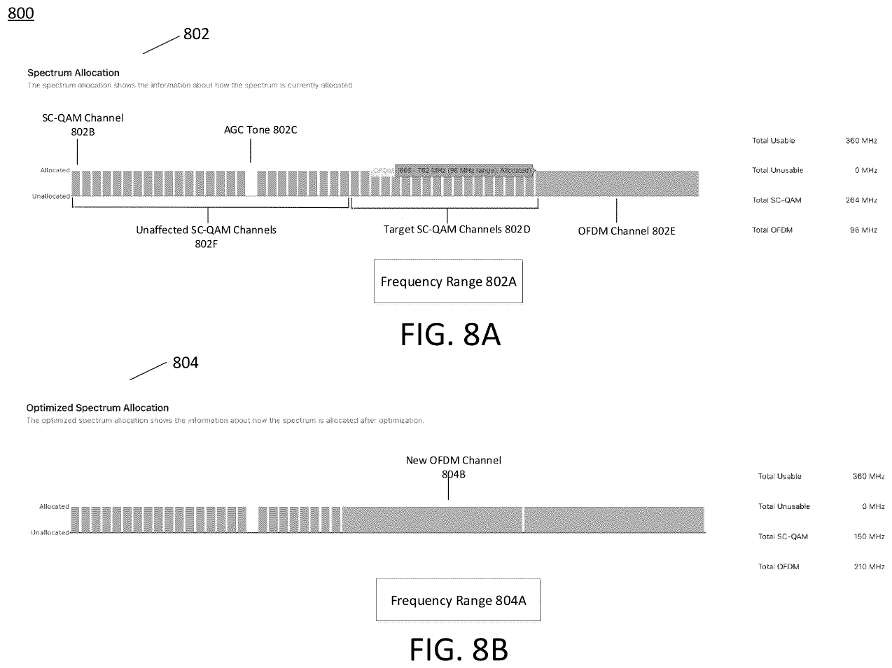

At step 502, the remote provisioner 310 may identify a current channel configuration. For example, the current channel configuration may look like the current channel configuration 802 of FIG. 8A. As shown in FIG. 8A, the current channel configuration 802 may be in a frequency range 802A, and include a set of SC-QAM channels, such as SC-QAM channel 802B, and an OFDM channel 802E. However, the current channel configuration is not limited to what is shown in FIG. 8A.

At step 504, the remote provisioner 310 may identify spectrum utilization data. Spectrum utilization may generally refer to how an RF channel or group of RF channels are being utilized by the modems 360₁-360_{N} in the service group 350. The utilization may be a percentage that ranges from 0-100%. A higher percentage utilization (e.g., 80%) means that a channel (e.g., SC-QAM channel 802B) is being utilized more by the modems 360₁-360_{N}. Further, there may be a utilization that refers to the utilization of an entire group of RF channels, such as an SC-QAM utilization which refers to the utilization of all the SC-QAM channels, and there may be an OFDM utilization, which refers to the utilization of all the OFDM channel(s). In computing the new channel configuration in step 510, the remote provisioner 310 may take into account how changing the channel configuration may affect the utilization of either the SC-QAM channels and/or the OFDM channel(s).

At step 506, the remote provisioner 310 may identify real-world constraints. Real-world constraints may include, for example, automatic gain control (AGC) tones (e.g., AGC tone 802C), local RF channel inserts, exclusion zones, the hardware limitations the RPD 340, etc. These constraints may limit certain frequency ranges/spectrum from being allocated by the remote provisioner 310 in computing the new channel configuration in step 510, and may be required to be “worked-around” in the computing of step 510.

At step 508, the remote provisioner may identify policy constraints. Policy constraints may be more flexible than the real-world constraints, and may be based on the characteristics of a particular service group (e.g., service group 350). For example, a policy constraint may include a maximum utilization of SC-QAM channels and/or OFDM channels or a supported data speed capability for specific modems. For example, an upper limit utilization of 60% may be used to ensure high service quality for the service group 350. However, the utilization may be changed based on the preferences of any given service group.

At step 510, the remote provisioner 310 may take the results of steps 502-508 and compute a new channel configuration for the service group 510. Table 1 below shows a list of example considerations/constraints that may be used by remote provisioner 310 as part of computing a new channel configuration in step 510.

TABLE 1
Real-World and Policy-Based Constraints

| Attribute | Common Value | | Description |
|---|---|---|---|
| SC-QAM/OFDM | 60% | | The utilization on both SC-QAM and OFDM may have upper |
| utilization upper limit | | | limits, such as 60%, to ensure high service quality. This means |
| | | | that the algorithm may need to ensure the estimated SC-QAM |
| | | | utilization and OFDM utilization may not exceed the given limit |
| | | | after the optimization/rebalance. This threshold may account for |
| | | | some years of compound annual growth rate (CAGR) which may |
| | | | influence this threshold to avoid increases in consumption growth |
| | | | that may require adding back SC-QAM spectrum. |
| RF tones | | | Existing tones such as automatic gain control (AGC) tones, local |
| | | | RF channel inserts, and video on demand (VoD) channels may |
| | | | need to be correctly handled for each service group. For example, |
| | | | analog AGC tones may not overlap with DOCSIS spectrum but |
| | | | may be “worked around” by adding exclusion zones in OFDM |
| | | | channels; digital AGC tones may require presence of neighboring |
| | | | power within a certain frequency range to the tone for an optimal |
| | | | level of performance. |
| Exclusion zones | | | Known exclusion zones may need to be considered in the |
| | | | optimization. For example, if a frequency range is known to |
| | | | suffer from ingress impairments, the algorithm may need to |
| | | | ensure that the SC-QAM channels may not overlap with the |
| | | | ingress. |
| Maximum data speed | | | Different modems may be expected to perform at different data |
| per modem type | | | speeds. Based on the modem's capabilities the spectrum |
| | | | configuration may need to provide sufficient capacity in the |
| | | | channels that the modem is capable of accessing. |
| Minimum number of | 24 | | A minimum number of SC-QAM channels, for example, 24, or |
| SC-QAM channels | | | 32 channels may be required to achieve maximum product data |
| | | | speed offers on D3.0 modems even if the overall capacity would |
| | | | accommodate a channel reduction. This constraint may also vary |
| | | | on a per service group basis. |
| SC-QAM channel | 6 | MHz | Allocation of SC-QAM channels may need to use a minimum |
| size | | | unit size. |
| OFDM channel size | 24-192 | MHz | The OFDM channels may have size limits. The DOCSIS 3.1 CM |
| limits | | | physical layer specification may allow an OFDM channel to be |
| | | | 24 MHz to 192 MHz wide, but this range may vary based on |
| | | | deployment requirements. |
| OFDM channel guard | 1 | MHz | The OFDM channels' guard band overhead may need to be |

| | |
|---|---|
| band size | accounted for by the algorithm. Such a requirement may allow |
| | for optimization accuracy and more meaningful reasoning for the |
| | recommendations when necessary. |
| SC-QAM applicable | The SC-QAM channels may have preferred frequency ranges in |
| frequency ranges | deployment. |
| Contiguous spectrum | The SC-QAM channels may require minimum allocation sizes, |
| allocation | for example, 4 contiguous channels per allocation block. |
| requirements | |
| Spectrum ordering | The SC-QAM channels may be preferred to be allocated to the |
| | lower frequency end, relative to the OFDM spectrum. |
| Hardware limitations | Hardware limitations such as the RPD chipset's capabilities can |
| | affect the maximum supported number of certain types of |
| | channels. |

For example, computing the new channel configuration may be modeled as an optimization problem, with various constraints and considerations factoring into the computing. A mixed-integer linear programming (MILP) algorithm may be used to the solve the optimization problem by modeling the constraints as linear inequalities, and solving the linear inequalities to find a new channel configuration that increases the network capacity of the service group 350. The following equations (1)-(9) and their explanation detail an example MILP algorithm to compute a new channel configuration, and in no way limits the present discussion on how a new channel configuration may be computed.

First, a definition of contiguous spectrum segment/channel may be created to represent a frequency range that may be freely used by DOCSIS channels. With this definition, constraints may be contained within each contiguous spectrum segment and be simplified. For example, constraints 2 and 3 in Table 1 may become preprocessing rules for identifying contiguous spectrum segments. Contiguous segments/channels may be two or more adjacent channels in any given frequency range. Because the objective of this optimization may be defined as maximizing the total spectral efficiency (e.g., linearly related to the total capacity), the objective function may be defined as:

$$The Objective Function$$

$$max {\sum }_{i = 1}^{N} {x}_{i} + α \times {y}_{i} \qquad Equation 1$$

where N may be the number of contiguous spectrum segments that may be reallocated and each of the segments may vary in their frequency ranges, xᵢ may be the target allocation of SC-QAM spectrum, yᵢ may the target allocation of OFDM spectrum (with guard bands subtracted), a may be the spectral efficiency ratio of OFDM/SC-QAM which suggested by the overall downstream capacity gain (˜44%) observed on OFDM channels.

For each individual contiguous spectrum segment, the total allocated spectrum may need to be smaller than or equal to the size (W) of the segment:

$$Total Spectrum Segment Constraint$$

$${x}_{i} + {y}_{i} + K \times {n}_{i} \leq {W}_{i} \qquad Equation 2$$

where xᵢ may be the target allocation of SC-QAM, yᵢ may be the target allocation of OFDM (with guard bands subtracted), K may be the total OFDM guard band size per OFDM channel, nᵢ may be the number of OFDM channels (to take OFDM's guard band overhead into consideration), and Wᵢ may be the size of the iₜₕ contiguous spectrum segment.

The allocated SC-QAM within each continuous spectrum segment may be divisible by the size of an SC-QAM channel, hence:

$$SC - QAM Allocation Minimum Unit Constraint$$

$${x}_{i} = {p}_{i} \times R \qquad Equation 3$$

where pᵢ may be an integer variable that represents the number of SC-QAM channels, and R may be the size of an SC-QAM channel.

Considering constraint 9 in Table 1, the allocated SC-QAM within a continuous spectrum segment may also be subject to an upper limit due to the maximum frequency an SC-QAM channel may be allocated:

$$SC - QAM Allocation Frequency Limit Constraint$$

$${x}_{i} \leq {η}_{i} \qquad Equation 4$$

where ηᵢ may be calculated by subtracting the continuous spectrum segment's starting frequency from the maximum frequency that an SC-QAM channel may be allocated.

A binary constraint may be used to represent the presence of OFDM and take OFDM's guard band overheads into account:

$$OFDM Allocation Constraint$$

$${c}_{i} \times M \geq {y}_{i} \qquad Equation 5$$

$${y}_{i} + ( 1 - {c}_{i} ) \times M \geq P - K$$

where cᵢ may be a binary variable that may indicate the OFDM presence in a contiguous spectrum segment, yᵢ may be the target OFDM allocation (with guard bands subtracted), P may be the minimum size of an OFDM channel (with guard bands included, e.g.: 24 MHz), K may be the OFDM guard band overhead (both guard bands), M may be a very large number to ensure that when OFDM is present, yᵢ may be greater than 0, cᵢ may need to be 1 to satisfy the first inequality, and in the second constraint, the OFDM size may need to meet its minimum size requirement. And additionally, when OFDM is not present, yᵢ may be equal to 0, the first constraint may always be satisfied, cᵢ becomes 0 because of minimization of overheads, and because M is a very large number, the second constraint may always be satisfied and the OFDM size variable of the contiguous spectrum segment may not need to meet the minimum size requirement.

Similarly, a binary constraint may be used to represent the presence of SC-QAM and ensure that enough number of SC-QAM channels may be allocated sequentially within a contiguous spectrum segment:

$$SC - QAM Allocation Constraint$$

$${b}_{i} \times M \geq {x}_{i} \qquad Equation 6$$

$${x}_{i} + ( 1 - {b}_{i} ) \times M \geq B$$

where bi may be a binary variable that may indicate the SC-QAM presence in the contiguous spectrum segment, xᵢ may be the target SC-QAM allocation, B may be the minimum required allocation for SC-QAM channels within a contiguous segment, M may be a very large number to ensure that when SC-QAM is present, xᵢ may be greater than 0, bi may need to be 1 to satisfy the first inequality, and in the second constraint the SC-QAM allocation may need to satisfy the minimum SC-QAM allocation constraint within a contiguous spectrum segment. And additionally, when SC-QAM is not present, xᵢ may be equal to 0, the first constraint may always be satisfied, and because M is a very large number, the second constraint is always satisfied.

Further, the number (minimum) of OFDM channels may need to be associated with the target OFDM allocation:

$$Minimum Number of OFDM Channels Constraint$$

$${n}_{i} \times ( Q - K ) \geq {y}_{i} \qquad Equation 7$$

where yᵢ may be the target allocation of OFDM (with guard-bands subtracted), K may be the total OFDM guard band size used by each OFDM channel, nᵢ may be the number of OFDM channels, and Q may be the maximum size of an OFDM channel (with guard bands included, e.g.: 192 MHz). This constraint may allow the minimum number of OFDM channels to be known as nᵢ and may be used in the constraint described by FIG. 2—Total Spectrum Segment Constraint to account for OFDM guard band overhead in the optimization. In some instances, the number of OFDM channels may also be influenced by the maximum speed by modem device type policy.

For the minimum total SC-QAM allocation requirement, such as 24 or 32 SC-QAM channels, the following constraint may be defined:

$$Minimum Total SC - QAM Allocation Constraint$$

$${\sum }_{i = 1}^{N} {x}_{i} \geq Γ \qquad Equation 8$$

where Γ may be the minimum required SC-QAM allocation. In some instances, the minimum total SC-QAM allocation may be initially calculated by the product speed per modem device type policy.

Finally, utilization constraints may be specified to provide the upper limits of estimated utilization values after optimization. Respectively, there may be SC-QAM utilization constraint and OFDM utilization constraint (i.e.: the utilization of SC-QAM/OFDM after optimization may not exceed 60% allowing 2 years of growth before service group augmentation. This policy can be made more aggressive as full automation is completed):

$$SC - QAM and OFDM Maximum Utilization Constaint$$

$${\sum }_{i = 1}^{N} {x}_{i} * Θ \geq L * β \qquad Equation 9$$

$${\sum }_{i = 1}^{N} {y}_{i} * Λ \geq H * γ$$

where L may be the original SC-QAM allocation, β may be the original SC-QAM utilization, θ may be the upper limit of SC-QAM utilization after optimization, H may be the original OFDM allocation, γ may be the original OFDM utilization, and \tilde{λ} may be the upper limit of the OFDM utilization after optimization.

In computing the new channel configuration, the remote provisioner 310 may compute a configuration similar to the new channel configuration 804 of FIG. 8B. Although the previous description for computing a new channel configuration is based on a MILP algorithm, other optimization algorithms may be used (e.g., a brute-force algorithm or a reinforcement learning model) without departing from the scope of the disclosure.

FIG. 6 is a flow chart showing an example method of implementing a new channel configuration for a service group. For ease of explanation, method 600 is discussed with respect to the system outlined in FIG. 3. However, it should be understood that the method 600 is not so limited to the specific embodiment of FIG. 3 The implementation of a new channel configuration may be performed while the modems 360₁-360_{N} in the service group 350 continue to transmit and receive information without an interruption to network service.

At step 602, the coordinator 320 may receive a new channel configuration. The new channel configuration may be received from the remote provisioner 310 based on the results performed in step 510 by the remote provisioner 310. For example, the new channel configuration may be similar to the new channel configuration 804 in FIG. 8B. At step 604, the coordinator 320 may compare the current channel configuration and new channel configuration. The comparison may be based on differences similar to the differences between the current channel configuration 802 of FIG. 8 and the new channel configuration 804 of FIG. 8B. For example, the target SC-QAM channels 802D (i.e., affected by the new channel configuration) may be replaced by the new OFDM channel 804B.

At step 606, the coordinator 320 may identify unaffected channels. As an example, the current channel configuration 802 of FIG. 8A and the new channel configuration 804 of FIG. 8B show a group of target SC-QAM channels 802D that may be replaced by the new OFDM channel 804B, and a group of SC-QAM channels unaffected (e.g., unaffected SC-QAM channels 802F) by the new channel configuration, such as SC-QAM channel 802B. The unaffected channels may be used by the coordinator 320 in implementing the new channel configuration without interrupting the service of the modems 360₁-360_{N}.

At step 608, the coordinator 320 may compute intermediate bonding groups. Computing the intermediate bonding groups may be based on the channels unaffected by the new channel configuration (e.g., based on unaffected SC-QAM channels 802F) and the particular characteristics of the modems 360₁-360_{N}. For example, a 4-channel D3.0 modem may be bonded to 4 SC-QAM channels (e.g., 4 of the unaffected SC-QAM channels 802F) as an intermediate bonding group, and an 8-channel D3.0 modem may be bonded to 8 SC-QAM channels (e.g., 8 of the unaffected SC-QAM channels 802F) as an intermediate bonding group. In some instances, in computing the intermediate bonding groups, the coordinator 320 may identify existing bonding groups that may be reused as intermediate bonding groups. In some instances, in computing the intermediate bonding groups, the coordinator 320 may create new bonding groups to be intermediate bonding groups. In some instances, load-balancing may be used to determine which of the unaffected SC-QAM channels to bond a modem to, in which modems are bonded to adjacent channels (e.g., a 4-channel D3.0 modem would be bonded to four adjacent channels of the unaffected channels). Load-balancing may further be used to ensure that all the modems (e.g., modems 360₁-360_{N}) are evenly spread across the unaffected channels (e.g., unaffected SC-QAM channels 802F).

In some instances, when the number of SC-QAM channels is less than a modem's maximum channel bonding capabilities, for example, a 32-channel D3.0 modem and 24 SC-QAM channels, the modem may be bonded to all 24 SC-QAM channels as an intermediate bonding group (limited by the number of SC-QAM channels which may be, e.g., 24). At step 610, the coordinator 320 may direct downstream modems to be moved or reassigned to intermediate bonding groups. This may be achieved using dynamic bonding change (DBC) messages, as discussed more with respect to FIG. 7.

In computing intermediate bonding groups and moving modems 360₁-360_{N} to intermediate bonding groups, modems 360₁-360_{N} may continue to transmit and receive information without an interruption to the network service of modems 360₁-360_{N} while the new channel configuration is being implemented. Without using intermediate bonding groups, modems 360₁-360_{N} may lose functionality when channels are turned off/on and part of provisioning the new spectrum.

At step 612, the coordinator 320 may direct the RPD 340 to switch from the current channel configuration to the new channel configuration. This may be done with channel configuration messages, as discussed in more detail with respect to FIG. 7. At step 614, the coordinator 320 may direct the modems 360₁-360_{N} to move to best-fit bonding groups. DBC messages may be used similarly to step 610. At step 616, the coordinator 320 may direct resource manager 330 to remove the previously used intermediate bonding groups.

FIGS. 7A-7D are a sequence showing an example method of remotely reconfiguring the network profile of a service group without an interruption to the network service of the service group. Referring to FIG. 7A, at step 701, the remote provisioner 310 may receive information from coordinator 320. The information received by the remote provisioner 310 may be similar to the information highlighted in steps 502-508 of FIG. 5. At step 702, the remote provisioner 320 may compute a new channel configuration. Computing the new channel configuration may be similar to what was performed in step 510 of FIG. 5.

At step 703, the remote provisioner 310 may send the new channel configuration to the coordinator 320. At step 704, the coordinator 320 may compare the current channel configuration with the new channel configuration. The comparison may be similar to the comparison performed in step 604 of FIG. 6.

Referring to FIG. 7B, at step 705, the coordinator 320 may identify unaffected channels (e.g., unaffected SC-QAM channels 802F). The identification may be similar to the identification that was performed in step 606 of FIG. 6. At step 706, the coordinator 320 may compute intermediate bonding groups. The computing may be similar to the computing that was performed at step 608 of FIG. 6.

At step 707, the coordinator 320 may generate dynamic bonding change messages. Dynamic bonding change messages are messages used to bond a particular modem (e.g., modem 360₁) to a group of RF channels that may be used in upstream/downstream communications. For example, if modem 360₁ is a 4-channel DOCSIS 3.0 modem, dynamic bonding change messages may be used to bond the modem 360₁ to 4 SC-QAM channels. DBC messages may be used to bond a modem to a different group of channels, for example, an intermediate bonding group, while the new channel configuration is being implemented. The coordinator 320 may generate DBC message to bond the modems 360₁-360_{N} in the service group 350 to a group of unaffected channels, and further based on the characteristics of the modems 360₁-360_{N}. Load-balancing, which may refer to evenly distributing modems across a group of channels, may be considered when moving modems 360₁-360_{N} to their respective intermediate bonding groups. Alternatively, dynamic channel change (DCC) messages may be similarly used for older modem devices that do not support D3.0 functionality.

At step 708, the coordinator 320 may direct the modems 360₁-360_{N} to be moved or reassigned to their respective intermediate bonding groups using the DBC messages that were previously generated by the coordinator 320 at step 707. In some instances, the intermediate bonding groups may be based on existing bonding groups, and, for example, one or more of the modems 360₁-360_{N} may use or reuse a corresponding existing bonding group. In some instances, the intermediate bonding groups may be based on newly created bonding groups. In some instances, there may be any combination of existing and newly created bonding groups as intermediate bonding groups without departing from the scope of the disclosure.

In some instances, an application programming interface (API) may be used by the coordinator 310 to send the DBC messages. In some instances, modems 360₁-360_{N} may send an indication to resource manager 330 and/or coordinator 320 to notify resource manager 330 and/or coordinator 320 that modems 360₁-360_{N} are bonded to respective intermediate bonding groups and may continue to transmit and receive information while the new channel configuration is being implemented. For example, the indication may be a medium access control (MAC) management message.

Referring to FIG. 7C, at step 709, the coordinator 320 may send the new channel configuration to the RPD 710. The new channel configuration may also include information that the RPD 340 may use to switch off old channels and add new channels based on the new channel configuration (e.g., switch off the target SC-QAM channels 802D and replace with the new OFDM channel 804B). In some instances, the coordinator 320 may use an API to communicate with the RPD 340.

At step 710, the RPD 330 may switch to the new channel configuration. For example, with reference to FIG. 8, the target SC-QAM channels 802D may be turned off, and new OFDM channel 804B may be turned on. At step 711, the coordinator 320 may compute best-fit bonding groups. Best-fit bonding groups may be computed based on the new channel configuration and the particular characteristics of each modem in a service group. For example, an 8-channel D3.0 modem may be bonded to 8 adjacent SC-QAM channels and a D3.1 modem may be bonded to an OFDM channel and/or adjacent SC-QAM channels. Load-balancing may be considered when moving modems 360₁-360_{N} to their respective best-fit groups.

Referring to FIG. 7D, at step 712, the coordinator 320 may generate dynamic bonding change messages. The DBC messages may be generated similarly to the generating in step 707. At step 713, the coordinator 320 may send the DBC messages to modems 360₁-360_{N}. In some instances, the DBC messages may pass through the resource manager 330 and RPD 340 to the modems 360₁-360_{N}, in which the DBC messages may be transformed from an API call/message to a medium access control (MAC) management message.

At step 714, the modems 360₁-360_{N} may move to their best-fit bonding groups based on the DBC messages sent in step 713. At step 715, the resource manager 330 may remove the intermediate bonding groups. In some instances, the coordinator 320 may remove the intermediate bonding groups. Although FIGS. 5-7 describe reconfiguring a network profile using downstream spectrum management, upstream spectrum management may similarly be used without departing from the scope of the disclosure.

FIGS. 8A-8B show a current channel configuration and a new channel configuration. FIG. 8A is a current channel configuration 802 with a set of SC-QAM channels and 1 OFDM channel within a frequency range 802A. FIG. 8A may also show an example SC-QAM channel 802B, an AGC Tone 802C, unaffected SC-QAM channels 802F, target SC-QAM channels 802D, and OFDM channel 802E. FIG. 8B is a new channel configuration 804 in a frequency range 804A, which may include new OFM channel 804B, which may be determined based on the actions performed in FIGS. 5-7.

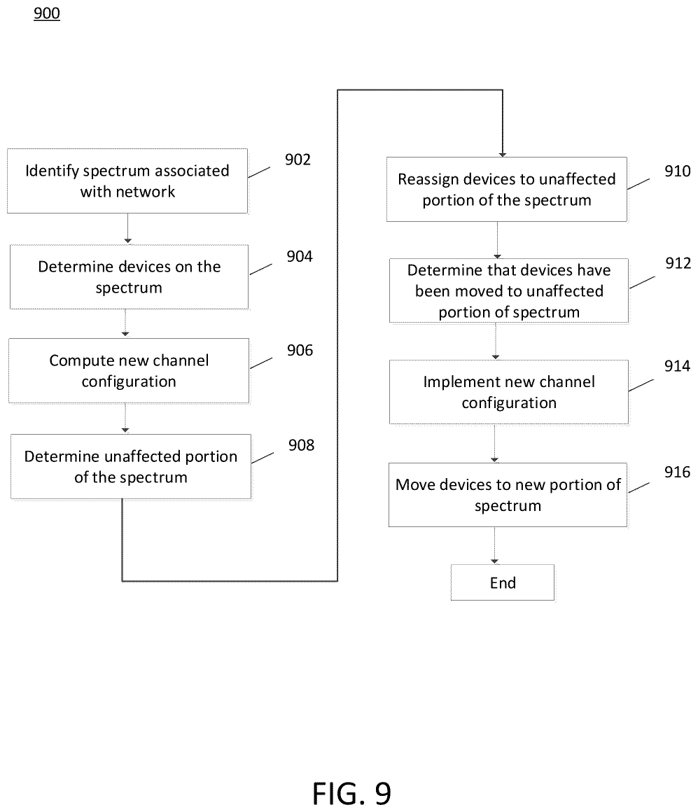

FIG. 9 is a flow chart showing an example method of remotely reconfiguring a network. Step 902 is identifying a spectrum associated with the network. Step 904 is determining a plurality of devices on the spectrum. Step 906 is computing a new channel configuration that increases network capacity on the spectrum. Step 908 is determining a portion of the spectrum that is unaffected by the new channel configuration. Step 910 is reassigning the plurality of devices to the unaffected portion of the spectrum. Step 912 is determining that the plurality of devices have been moved to the unaffected portion of the spectrum. Step 914 is implementing the new channel configuration. Step 916 is moving the plurality of devices to a new portion of the spectrum. The previously mentioned steps may be performed by a combination of the devices in FIGS. 3 and 4 in a similar manner to the steps in FIGS. 5-7.

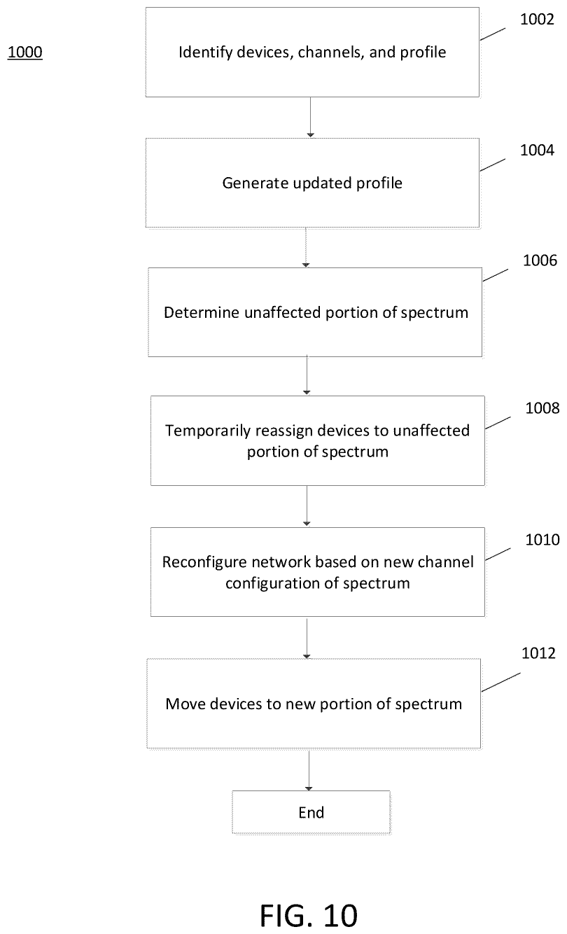

FIG. 10 is a flow chart showing an example method of remotely reconfiguring a network. Step 1002 is identifying a plurality of devices, channels, and a profile associated with the network. Step 1004 is generating, using the provisioner, an updated profile, wherein the updated profile comprises a new channel configuration of the spectrum that increases network capacity of the network. Step 1006 is determining an unaffected portion of the spectrum. Step 1008 is temporarily reassigning the plurality of devices to the unaffected portion of the spectrum. Step 1010 is reconfiguring the network based on the new channel configuration of the spectrum. Step 1012 is moving the plurality of devices to a new portion of the spectrum. The previously mentioned steps may be performed by a combination of the devices in FIGS. 3 and 4 in a similar manner to the steps in FIGS. 5-7.

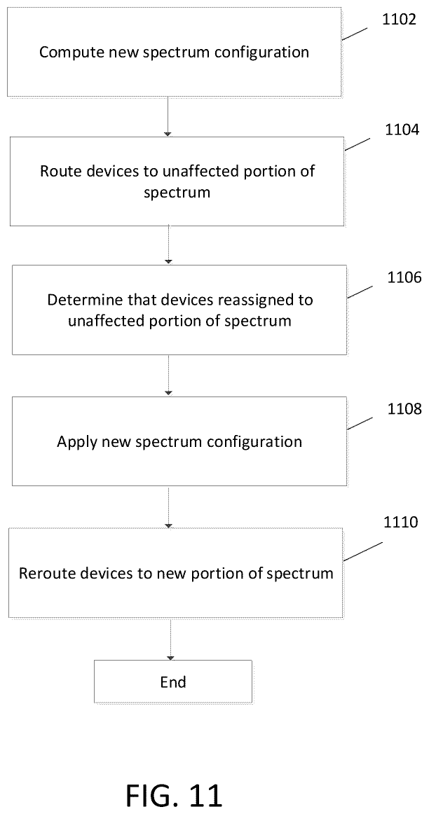

FIG. 11 is a flow chart showing an example method of remotely reconfiguring a network. Step 1102 is computing a new spectrum configuration that increases capacity of the network using a mixed-integer linear programmer. Step 1104 is routing a plurality of devices to an unaffected portion of the spectrum. Step 1106 is determining that the plurality of devices is reassigned to the unaffected portion of the spectrum. Step 1108 is applying the new spectrum configuration. Step 1110 is rerouting the plurality of devices to a new portion of the spectrum. The previously mentioned steps may be performed by a combination of the devices in FIGS. 3 and 4 in a similar manner to the steps in FIGS. 5-7.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method of managing a network comprising:
identifying a spectrum associated with the network;
determining a plurality of devices on the spectrum;
computing a new channel configuration of the spectrum that increases network capacity on the spectrum;
determining a portion of the spectrum that is unaffected by the new channel configuration;
reassigning the plurality of devices to the portion of the spectrum that is unaffected by the new channel configuration using a plurality of intermediate bonding groups;
determining that the plurality of devices have been moved to the portion of the spectrum that is unaffected by the new channel configuration using the intermediate bonding groups;
implementing the new channel configuration on the spectrum; and
moving the plurality of devices to a new portion of the spectrum based on the new channel configuration.

2. The method of claim 1, further comprising:
identifying a profile associated with the network, wherein the profile comprises information identifying the plurality of devices; and
information identifying a current channel configuration of the spectrum, wherein the current channel configuration comprises a plurality of channels that are used by the plurality of devices to transmit and receiving information over the network.

3. The method of claim 1, further comprising:
determining an updated profile, wherein the updated profile comprises the new channel configuration configured to increase the network capacity of on the spectrum compared with the current channel configuration.

4. The method of claim 2, wherein the current channel configuration further comprises:
a plurality of single carrier quadrature amplitude modulation (SC-QAM) channels and an orthogonal frequency division multiplexing (OFDM) channel.

5. The method of claim 2, wherein the profile further comprises:
characteristics associated with the network, the plurality of devices, and the plurality of channels.

6. The method of claim 2, wherein the determining the portion of the spectrum that is
unaffected by the new channel configuration
is based on differences between the current channel configuration and the new channel configuration.

7. The method of claim 2, wherein the plurality of devices may continue to transmit and receive information over the network using the intermediate bonding groups during the implementing.

8. The method of claim 2, wherein the plurality of intermediate bonding groups are further determined based on the unaffected channels and characteristics associated with the plurality of devices.

9. The method of claim 5, wherein the characteristics further comprise the current channel configuration, utilization data, policy constraints, and real-world constraints.

10. The method of claim 8, wherein the devices are moved to the plurality of intermediate bonding groups using dynamic bonding change messages.

11. A method of remotely managing a network comprising:
identifying:
a plurality of devices associated with the network;
a plurality of channels associated with the network; and
a profile associated with the network, wherein the profile comprises information indicating a spectrum that the plurality of devices use to transmit and receive data on the spectrum;
generating, using a provisioner, an updated profile, wherein the updated profile comprises a new channel configuration of the spectrum that improves network capacity of the network;
determining a portion of the spectrum that is unaffected by the new channel configuration;
temporarily reassigning the devices to the portion of the spectrum that is unaffected by the new channel configuration;
reconfiguring the network, using a coordinator, based on the new channel configuration of the spectrum; and
moving the devices to a new portion of the spectrum based on the new channel configuration.

12. The method of claim 11, wherein the profile comprises a current channel
configuration that is different from the new channel configuration.

13. The method of claim 12, wherein the reconfiguring further comprises:
determining a plurality of intermediate bonding groups based on differences between the current channel configuration and the new channel configuration.

14. The method of claim 13, wherein the devices may continue to transmit and receive data over the network using the intermediate bonding groups.

15. The method of claim 14, further comprising moving the devices from the intermediate bonding groups to best-fit bonding groups after the reconfiguring using dynamic bonding change messages.

16. A method of remotely managing a spectrum associated with a network comprising:
computing a new spectrum configuration that increases capacity of the network using a mixed-integer linear programmer;
routing a plurality of devices on the network to a portion of the spectrum that is unaffected by the new spectrum configuration;
determining that the plurality devices have been reassigned to the portion of the spectrum that is unaffected by the new spectrum configuration;
applying the new spectrum configuration while the plurality of devices continue to transmit and receive data using the portion of the spectrum that is unaffected by the new spectrum configuration; and
rerouting the plurality of devices to a new portion of the spectrum based on the new spectrum configuration.

17. The method of claim 16, further comprising a profile that comprises:
the plurality of devices associated with the network;
a plurality of channels associated with the network that are used by the plurality of network devices to transmit and receive data over the network; and
a current spectrum configuration associated with the plurality of channels.

18. The method of claim 17, further comprising an updated profile that comprises the new spectrum configuration.

19. The method of claim 18, further comprising:
determining intermediate bonding groups based on characteristics associated with the plurality of devices and differences between the current spectrum configuration and the new spectrum configuration.

20. The method of claim 19, wherein the rerouting further comprises:
generating dynamic bonding change messages that direct the devices to move to the portion of the spectrum that is unaffected by the new spectrum configuration.
